(19) United States
(12) Patent Application Publication
(10) Pub. No.: US 2025/0220536 A1
(43) Pub. Date: Jul. 3, 2025

(54) METHOD AND APPARATUS OF SUPPORTING QUALITY OF EXPERIENCE (QoE) MEASUREMENT COLLECTION

(71) Applicant: Lenovo (Beijing) Limited, Beijing (CN)

(72) Inventors: Mingzeng Dai, Shanghai (CN); Lianhai Wu, Beijing (CN); Le Yan, Shanghai (CN); Xiaoying Xu, Shanghai (CN); Haiyan Luo, Shanghai (CN)

(73) Assignee: Lenovo (Beijing) Limited, Beijing (CN)

(21) Appl. No.: 18/881,500

(22) PCT Filed: Jul. 8, 2022
(86) PCT No.: PCT/CN2022/104604

§ 371 Date: Jan. 6, 2025

(51) Int. Cl. H04W 36/14; H04L 41/5067; H04W 36/08

(52) U.S. Cl. CPC H04W 36/144; H04L 41/5067; H04W 36/08

(57) ABSTRACT

Methods and apparatuses of supporting QoE measurement collection are provided. An exemplary method may include: transmitting, to a UE (102), first information indicating configuration of at least one set of QoE measurement, wherein, each set of QoE measurement includes one or more QoE measurements for a same service type and different sets of QoE measurement are for different service types; and transmitting, to the UE (102), second information indicating configuration of at least one QoE measurement in response to an inter-RAT handover to a target RAN node, wherein the at least one QoE measurement is selected from the at least one set of QoE measurement, and different QoE measurements of the at least one QoE measurement are for different service types.

### TECHNICAL FIELD

Embodiments of the present application generally relate to wireless communication technology, especially to a method and apparatus of supporting quality of experience (QoE) measurement collection (QMC, also referred to as QoE, QoE measurement, or QoE measurement collection job etc.).

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

In 3GPP release (Rel)-17, the basic mechanism for NR QoE is specified, e.g., the basic mechanisms for triggering, configuration, collection, mobility support and reporting of QoE measurement etc. However, only the QoE measurement collection continuity for intra-system intra-radio access technology (RAT) mobility is supported in Rel-17. It is expected that the support for QoE measurement collection continuity for intra-system inter-RAT mobility will be achieved in Rel-18.

Thus, the industry desires technology to support QoE measurement collection continuity for intra-system inter-RAT mobility.

### SUMMARY OF THE APPLICATION

One objective of the embodiments of the present application is to provide a technical solution of supporting QoE measurement collection, e.g., a method and apparatus of supporting QoE measurement collection continuity for intra-system inter-RAT mobility.

Some embodiments of the present application provide a radio access network (RAN) node, e.g., a gNB, which includes: a processor; and a transceiver coupled to the processor, wherein the transceiver is configured to: transmit, to a user equipment (UE), first information indicating configuration of at least one set of QoE measurement, wherein, each set of QoE measurement includes one or more QoE measurements for a same service type and different sets of QoE measurement are for different service types; and transmit, to the UE, second information indicating configuration of at least one QoE measurement in response to an inter-RAT handover to a target RAN node, wherein the at least one QoE measurement is selected from the at least one set of QoE measurement, and different QoE measurements of the at least one QoE measurement are for different service types.

In some embodiments of the present application, the transceiver is further configured to: receive information indicating QoE measurement continuity after inter-RAT handover from an OAM system, or from the OAM system via a core network (CN), wherein the at least one QoE measurement is selected based on the information indicating QoE measurement continuity after inter-RAT handover.

According to some embodiments of the present application, the information indicating QoE measurement continuity after inter-RAT handover indicates which QoE measurement for a service type is continued after inter-RAT handover, or indicates continuity priority of each QoE measurement for a service type after inter-RAT handover. In the case that there is only one QoE measurement in a set of QoE measurement, the information indicating QoE measurement continuity after inter-RAT handover is a service type.

According to some embodiments of the present application, the transceiver is configured to: transmit the information indicating QoE measurement continuity after inter-RAT handover to the UE with the first information.

According to some embodiments of the present application, the transceiver is configured to: transmit the information indicating QoE measurement continuity after inter-RAT handover to the UE with the second information.

According to some embodiments of the present application, the processor is configured to: select the at least one QoE measurement based on the information indicating QoE measurement continuity; and the transceiver is configured to: transmit third information indicating only the configuration of the at least one QoE measurement to the target RAN node; and receive the second information indicating the configuration of the at least one QoE measurement from the target RAN node, wherein the configuration of the at least one QoE measurement indicated in the second information is generated or updated based on the configuration of the at least one QoE measurement indicated in the third information. Each configuration of the at least one QoE measurement indicated in the second information is identified by a corresponding service type.

According to some embodiments of the present application, the transceiver is configured to: transmit third information indicating configuration of the at least one set of QoE measurement and the information indicating QoE measurement continuity after inter-RAT handover to the target RAN node; and receive the second information indicating the configuration of the at least one QoE measurement from the target RAN node, wherein the configuration of the at least one QoE measurement indicated in the second information is generated or updated based on the configuration of the at least one set of QoE measurement indicated in the third information. Exemplary third information further includes a measurement configuration application layer identifier allocated by the RAN node to the UE of each configuration of the at least one set of QoE measurement; and the second information further includes the measurement configuration application layer identifier of each configuration of the at least one QoE measurement. In an example, the transceiver is configured to: receive information indicating QoE measurement to be released from the target RAN node; and transmit the information indicating QoE measurement to be released to the UE. In another example, the transceiver is configured to: receive information indicating QoE measurement to be continued from the target RAN node; and transmit the information indicating QoE measurement to be continued to the UE. In yet another example, the third information and the information indicating QoE measurement continuity after inter-RAT handover is transmitted to the target RAN node via a handover request message or via a source to target transparent container.

In some embodiments of the present application, the transceiver is configured to: transmit information indicating QoE measurement continuity after inter-RAT handover to the UE by indicating releasing other QoE measurement of the at least one set of QoE measurement except for the at least one QoE measurement.

In some embodiments of the present application, the RAN node is a gNB and the target RAN node is a ng-eNB.

In some embodiments of the present application, the configuration of at least one set of QoE measurement indicated in the first information is in a first RAT, and the configuration of at least one QoE measurement indicated in the second information is in a second RAT different from the first RAT.

Some embodiments of the present application provide a RAN node, e.g., a ng-eNB, which includes: a processor; and a transceiver coupled to the processor, wherein the transceiver is configured to: receive, from a source RAN node in response to an inter-RAT handover, first information indicating configuration of at least one set of QoE measurement, wherein, each set of QoE measurement includes one or more QoE measurements for a same service type and different sets of QoE measurement are for different service types; and transmit, to the source RAN node, second information indicating configuration of at least one QoE measurement, wherein, the at least one QoE measurement is selected from the at least one set of QoE measurement, and different QoE measurements of the at least one QoE measurement are for different service types.

In some embodiments of the present application, the transceiver is configured to: receive information indicating QoE measurement continuity after inter-RAT handover from the source RAN node; and the transceiver is configured to: select the at least one QoE measurement from the at least one set of QoE measurement based on the information indicating QoE measurement continuity after inter-RAT handover.

According to some embodiments of the present application, the information indicating QoE measurement continuity after inter-RAT handover indicates which QoE measurement for a service type is continued after inter-RAT handover, or indicates continuity priority of each QoE measurement for a service type after inter-RAT handover.

In some embodiments of the present application, the configuration of the at least one QoE measurement indicated in the second information is generated or updated based on the configuration of the at least one set of QoE measurement indicated in the first information.

In some embodiments of the present application, the transceiver is configured to: transmit information indicating QoE measurement to be released to the source RAN node.

In some embodiments of the present application, the transceiver is configured to: transmit information indicating QoE measurement to be continued to the source RAN node.

In some embodiments of the present application, the information indicating QoE measurement continuity after inter-RAT handover is received from the source RAN node via a handover request message or a source to target transparent container.

In some embodiments of the present application, the RAN node is a ng-eNB and the source RAN node is a gNB.

In some embodiments of the present application, the first information further includes a measurement configuration application layer identifier allocated by the RAN node to the UE of each configuration of the at least one set of QoE measurement; and the second information further includes the measurement configuration application layer identifier of each configuration of the at least one QoE measurement.

In some embodiments of the present application, the configuration of at least one set of QoE measurement indicated in the first information is in a first RAT, and the configuration of at least one QoE measurement indicated in the second information is in a second RAT different from the first RAT.

Some embodiments of the present application provide a RAN node, e.g., a ng-eNB, which includes: a processor; and a transceiver coupled to the processor, wherein the transceiver is configured to: transmit, to a target RAN node in response to an inter-RAT handover, information indicating at least one QoE measurement and information indicating that the at least one QoE measurement has been configured to a UE with first RAT identification information, wherein, different QoE measurements of the at least one QoE measurement are for different service types; receive, from the target RAN node, second RAT identification information and information of associating the at least one QoE measurement with second RAT identification information; and transmit, to the UE, the second RAT identification information and the information of associating the at least one QoE measurement with the second RAT identification information.

In some embodiments of the present application, the first RAT identification information is a service type, and the second RAT identification information is measurement configuration application layer identifier.

In some embodiments of the present application, the information of associating the at least one QoE measurement with the second RAT identification information is indicated by the second RAT identification information implicitly.

In some embodiments of the present application, the RAN node is a ng-eNB and the target RAN node is a gNB.

Some embodiments of the present application provide a RAN node, e.g., a gNB, which includes: a processor; and a transceiver coupled to the processor, wherein the transceiver is configured to: receive, from a source RAN node in response to an inter-RAT handover, information indicating at least one QoE measurement and information indicating that the at least one QoE measurement has been configured to a UE with first RAT identification information, wherein, different QoE measurements of the at least one QoE measurement are for different service types; and transmit, to the source RAN node, second RAT identification information and information of associating the at least one QoE measurement identified by the first RAT identification information with the second RAT identification information.

In some embodiments of the present application, the RAN node is a gNB and the source RAN node is a ng-eNB.

Some embodiments of the present application provide a remote apparatus, e.g., a UE, which includes: a processor; and a transceiver coupled to the processor, wherein the transceiver is configured to: receive, from a RAN node, first information indicating configuration of at least one set of QoE measurement, wherein, each set of QoE measurement includes one or more QoE measurements for a same service type and different sets of QoE measurement are for different service types; and receive, from the RAN node, second information indicating configuration of at least one QoE measurement in response to an inter-RAT handover from the RAN node to a target RAN node, wherein the at least one QoE measurement is selected from the at least one set of QoE measurement, and different QoE measurements of the at least one QoE measurement are for different service types.

In some embodiments of the present application, the transceiver is further configured to: receive information indicating QoE measurement continuity after inter-RAT handover with at least one of the first information or the second information; and continue the at least one QoE measurement after inter-RAT handover based on the information indicating QoE measurement continuity after inter-RAT handover.

In some embodiments of the present application, the transceiver is configured to: receive information indicating that other QoE measurement of the at least one set of QoE measurement except for the at least one QoE measurement is to be released in response to the inter-RAT handover; and the processor is configured to: release the other QoE measurement of the at least one set of QoE measurement.

In some embodiments of the present application, the transceiver is configured to: receive information indicating that the at least one QoE measurement is to be continued in response to the inter-RAT handover; and the processor is configured to: continue the at least one QoE measurement after the inter-RAT handover.

According to some embodiments of the present application, in the case that the information indicating QoE measurement continuity after inter-RAT handover is received with the first information, each configuration of the at least one QoE measurement indicated in the second information is identified by a corresponding service type.

According to some embodiments of the present application, in the case that the information indicating QoE measurement continuity after inter-RAT handover is received with the second information, the information indicating QoE measurement continuity after inter-RAT handover is indicated by a measurement application layer identifier included in the second information, and the measurement application layer is allocated by the source RAN node.

In some embodiments of the present application, the configuration of at least one set of QoE measurement indicated in the first information is in a first RAT, and the configuration of at least one QoE measurement indicated in the second information is in a second RAT different from the first RAT.

In view of the above, embodiments of the present application at least provide a technical solution of supporting QoE measurement collection, e.g., a method and apparatus of supporting QoE measurement collection continuity for intra-system inter-RAT mobility, which considers both the scenarios from a source RAN node supporting more than one QoE measurement per service type to a target RAN node supporting only one QoE measurement per service type, and the scenarios from a source RAN node supporting only one QoE measurement per service type to a target RAN node supporting more than one QoE measurement per service type. Accordingly, the present application can facilitate and improve the implementation of NR.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a wireless communication system according to some embodiments of the present application.

FIG. 2 is a flow chart illustrating a method of supporting QoE measurement collection in Scenarios 1 according to some embodiments of the present application.

FIG. 3 is a flow chart illustrating a method of supporting QoE measurement collection with Scheme 1 in Scenarios 1 according to some embodiments of the present application.

FIG. 4 is a flow chart illustrating a method of supporting QoE measurement collection with Scheme 2 in Scenarios 1 according to some other embodiments of the present application.

FIG. 5 is a flow chart illustrating a method of supporting QoE measurement collection in Scenarios 2 according to some embodiments of the present application

FIG. 6 illustrates a block diagram of an apparatus of supporting QoE measurement collection according to some embodiments of the present application.

FIG. 7 illustrates a block diagram of an apparatus of supporting QoE measurement collection according to some other embodiments of the present application.

### DETAILED DESCRIPTION

The detailed descriptions of the appended drawings are intended as descriptions of preferred embodiments of the present application and are not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP long term evolution (LTE), and so on. It is contemplated that along with the developments of network architectures and new service scenarios, all embodiments in the present application are also applicable to similar technical problems. Moreover, the terminologies recited in the present application may change, which should not affect the principle of the present application.

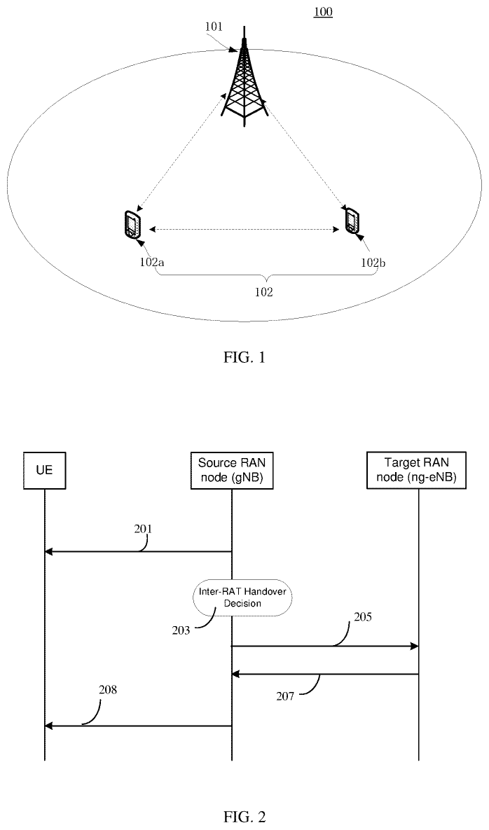

FIG. 1 illustrates a schematic diagram of an exemplary wireless communication system 100 according to some embodiments of the present application.

As shown in FIG. 1, the wireless communication system 100 includes at least one BS 101 and at least one UE 102. In particular, the wireless communication system 100 includes one BS 101 and two terminal device 102 (e.g., a first UE 102a and a second UE 102b) for illustrative purpose. Although a specific number of BSs and terminal devices are illustrated in FIG. 1 for simplicity, it is contemplated that the wireless communication system 100 may include more or less BSs and terminal devices in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may communicate with a CN node (not shown), e.g., a mobility management entity (MME) or a serving gateway (S-GW), an access and mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node. Each BS may serve a number of UE(s) within a serving area, for example, a cell or a cell sector via a wireless communication link. Neighbor BSs may communicate with each other as necessary, e.g., during a handover procedure for a UE.

The terminal device (or remote apparatus) 102, e.g., the first UE 102a and the second UE 102b may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the terminal device may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the terminal device may include wearable devices, such as smart watches, fitness bands, optical head-mounted displays, or the like. Moreover, the terminal device may be referred to as a subscriber unit, a mobile, a mobile station, a user, a terminal, a mobile terminal, a wireless terminal, a fixed terminal, a subscriber station, a user terminal, or a device, or described using other terminology used in the art. Herein (through the specification), although “UE” is used exemplarily as a classical terminal device for illustrating the terminal device, it should be understood as any type terminal device.
In 3GPP Rel-17, the basic mechanism for NR QoE is specified. For example, regarding QoE measurement collection activation and reporting, TS38. 300 specifies the following:

“The feature is activated in the NG-RAN either by direct configuration from the OAM system (management-based activation), or by signalling from the OAM via the Core Network (signalling-based activation), containing UE-associated QoE configuration. One or more QoE measurement collection jobs can be activated at a UE per service type, and each QoE measurement configuration is uniquely identified by a QoE Reference.
For signalling-based QoE measurements, the OAM initiates the QoE measurement activation for a specific UE via the Core Network, and the NG-RAN node receives one or more QoE measurement configurations by means of UE-associated signalling. The QoE measurement configuration for signalling-based activation includes an application layer measurement configuration list and the corresponding information for QoE measurement collection, e.g., QoE Reference, service type, MCE IP Address, Slice Scope, Area Scope, MDT Alignment Information and the indication of available RAN visible QoE metrics. Each application layer measurement configuration is encapsulated in a transparent container. The NG-RAN node forwards the corresponding QoE measurement configuration(s) to the UE in a downlink RRC message containing AppLayerMeasConfig, as specified in TS38.331 [12].
For management-based QoE measurement activation, the OAM sends one or more the QoE measurement configurations to the NG-RAN node. The QoE measurement configuration for management-based activation also includes an application layer measurement configuration list and the corresponding information for QoE measurement collection. Each application layer measurement configuration is encapsulated in a transparent container. The NG-RAN node selects UE(s) that meet the required QoE measurement capability, Area Scope and Slice Scope.
The UE reports QoE measurement results to the NG-RAN node in an uplink RRC message, as specified in TS38.331[12]. The NG-RAN node transmits the QoE report and the corresponding QoE Reference ID to the MCE.
The QoE measurement collection is handled by application layer measurement configuration and measurement reporting, supported in RRC_CONNECTED state only. Application layer measurement configuration received by the gNB from OAM or CN is encapsulated in a transparent container, which is forwarded to a UE as Application layer configuration in the RRCReconfiguration message (there can be multiple configurations in the same message). Application layer measurement reports received from UE's higher layer are encapsulated in a transparent container and sent to the network in the MeasurementReportAppLayer message, as specified in TS 38.331 [12]. The UE can send multiple application layer measurement reports to the gNB in one MeasurementReportAppLayer message. In order to allow the transmission of application layer measurement reports which exceed the maximum PDCP SDU size, segmentation of the MeasurementReportAppLayer message may be enabled by the gNB. A measConfigAppLayerId conveyed in the RRC signalling is used to identify the application layer measurement configuration and report between the gNB and the UE. The RRC identifier is mapped to the QoE Reference in the gNB. The application layer measurement report is forwarded to OAM together with the QoE Reference. gNB can release one or multiple application layer measurement configurations from the UE in one RRCReconfiguration message at any time. The UE may additionally be configured by the gNB to report when a QoE measurement session starts or stops for a certain application layer measurement configuration.”

Thus, QoE measurement collection can be activated by two manners, i.e., management-based activation and signalling-based activation. In the case of management-based activation, the RAN node, e.g., a gNB receives direct configuration from the OAM (or OAM system). In the case of signalling-based activation, the RAN node receives signalling containing UE-associated QoE configuration from the OAM via the CN. The application layer measurement configuration received by the gNB from the OAM or CN is encapsulated in a transparent container in Rel-17, which is forwarded to a UE as application layer configuration in a RRCReconfiguration message (there can be multiple configurations in the same message). Application layer measurement reports received from UE's application layer are encapsulated in a transparent container and sent to the network in a MeasurementReportAppLayer message. In order to allow the transmission of application layer measurement reports which exceed the maximum PDCP SDU size, segmentation of the MeasurementReportAppLayer message may be enabled by the gNB.

TS 38. 300 also specifies QoE measurement continuity for mobility as follows:
“The QoE Measurement Collection continuity for intra-system intra-RAT mobility is supported, with the Area Scope parameters configured by the OAM, where the network is responsible for keeping track of whether the UE is inside or outside the Area Scope. A UE should continue an ongoing measurement even if it leaves the Area Scope, unless the network indicates to the UE to release the QoE configuration.
For RRC_CONNECTED state mobility, the source NG-RAN node may transmit the QoE measurement configuration(s) and/or the information related to the configuration(s) of a specific UE to the target NG-RAN node via XnAP or NGAP. For signaling-based QoE, QoE Reference, MCE IP Address, Measurement Configuration Application layer ID, MDT Alignment Information, Area Scope, Slice Scope and Measurement Status are passed to the target node. For management-based QoE, Measurement Configuration Application Layer ID, MCE IP Address and Measurement Status are passed to the target node. For RRC_INACTIVE state mobility, QoE measurement configuration(s) of a specific UE can be restored from the node hosting the UE context when it resumes to RRC_CONNECTED state. Multiple sets of QoE measurement configurations should be supported during mobility.
For signalling based QoE, at handover to a target gNB which supports QoE, the target gNB decides which application layer measurement configurations to keep and which to release, e.g. based on application layer measurement configuration information received from the source gNB in Xn/NG signalling.

When the UE resumes the connection in a gNB not supporting QoE, the UE releases all application layer measurement configurations.”

It can be seen that, Rel-17 only specifies the QoE measurement collection continuity for intra-system intra-RAT mobility. Regarding QoE measurement collection continuity for intra-system inter-RAT mobility, it is expected to be solved in Rel-18. For example, according to RP-213159, it has been agreed: “Support the continuity of legacy QoE measurement job for streaming and MTSI service during intra-5GC inter-RAT handover process [RAN2, RAN3].” Related issues to be solved include but not limited to: issues caused by QoE measurement capability mismatch between two different RATs, e.g., mismatch between NR QoE measurement collection capability and LTE QoE measurement collection capability. The term of LTE refers to evolved universal terrestrial radio access (E-UTRA). The ‘LTE’ is used for convenience. ‘LTE’ can be replaced by ‘E-UTRA’ when the BS is connected with 5GC. The RAN node in the intra-system intra-RAT is an NG-RAN node. An NG-RAN node is either: a gNB, providing NR user plane and control plane protocol terminations towards the UE and connected via the NG interface to the 5GC; or an ng-eNB, providing E-UTRA user plane and control plane protocol terminations towards the UE and connected via the NG interface to the 5GC.

Specifically, NR QoE supports multiple QoE measurements per service type, wherein the QoE measurement (including QoE measurement configuration and QoE measurement report) is identified by NR QoE identification information, e.g., a measurement configuration application layer identifier (ID) (currently specified as “measConfigAppLayerld” in 3GPP specification). A measurement configuration application layer ID can be conveyed in a radio resource control (RRC) signalling as a RRC identifier to identify the application layer measurement configuration and report between the gNB and the UE. One or more QoE measurement collection jobs can be activated at a UE per service type, and each QoE measurement configuration is uniquely identified by a QoE reference (e.g., QoE reference ID), wherein the measConfigAppLayerld is mapped to the QoE reference in the gNB.

However, LTE QoE only supports a single QoE measurement per service type, and each QoE measurement collection job is implicitly identified by the QoE service type. There is no additional identification information for different QoE measurement collection jobs in LTE QoE. Currently, there are two service types supported in LTE QoE, i.e., streaming services and multimedia telephony service for IP multimedia subsystem (IMS) (MTSI) services. Accordingly, there are two types of LTE QoE measurement, one is QoE measurement collection for streaming services and the other is QoE measurement collection for MTSI services.

In some scenarios where an inter-RAT handover is from a source RAN node (e.g., a gNB) supporting NR QoE or the like to a target RAN node (e.g., a ng-eNB) supporting LTE QoE or the like other than NR QoE (hereafter, Scenarios 1), more than one QoE measurement collection job may have been activated for a certain service type (e.g. streaming services or MTSI services) in the source gNB. However, the target ng-eNB can only support one QoE measurement collection job for the service type. Thus, how to ensure the UE to determine one QoE measurement collection job with QoE measurement continuity from the more than one QoE measurement collection job per service type should be solved.

On the other hand, in some other scenarios where an inter-RAT handover is from a source RAN node supporting LTE QoE (e.g., a ng-eNB) to a target RAN node supporting NR QoE (e.g., a gNB) (hereafter, Scenarios 2), how to configure the NR QoE measurement identification information, e.g., measConfigAppLayerld with QoE measurement continuity for the QoE measurement only identified by a service type to ensure the UE to continue and report the correct QoE measurement also should be solved.

Given the above, at least to support QoE measurement collection continuity for intra-system inter-RAT mobility, embodiments of the present application provide a technical solution of supporting QoE measurement collection, especially methods and apparatuses of supporting QoE measurement collection. Although an exemplary inter-RAT handover illustrated herein is between a NR RAN node, e.g., a gNB to a LTE RAN node, e.g., a ng-eNB, persons skilled in the art should well know that the terminology, especially “NR” and “gNB” may change as the evolution of 3GPP. Any inter-RAT handover between a RAN node with a RAT supporting more than one QoE measurement collection job per service type and a RAN node with another RAT supporting only one QoE measurement collection job per service type will cause the same issues, which will be solved by technical solutions disclosed in embodiments of the present application.

For example, considering Scenarios 1, some embodiments of the present application provide a method, which may be performed by a RAN node (e.g., a source gNB or the like) with a RAT supporting more than one QoE measurement collection job per service type. The exemplary method includes: transmitting first information indicating configuration of at least one set of QoE measurement to a UE; and transmitting second information indicating configuration of at least one QoE measurement to the UE in response to an inter-RAT handover to a target RAN node, (e.g., a ng-eNB or the like) with another RAT supporting only one QoE measurement collection job per service type. Each set of QoE measurement includes one or more QoE measurements for the same service type and different sets of QoE measurement are for different service types. The at least one QoE measurement is selected from the at least one set of QoE measurement, and different QoE measurements of the at least one QoE measurement are for different service types.

Some other embodiments of the present application provide another method, which may be performed by a RAN node supporting only one QoE measurement per service type, e.g., a target ng-eNB or the like. The exemplary method includes: receiving, from a source RAN node (e.g., a gNB or the like) supporting more than one QoE measurement per service type in response to an inter-RAT handover, first information indicating configuration of at least one set of QoE measurement; and transmitting, to the source RAN node, second information indicating configuration of at least one QoE measurement. Similarly, each set of QoE measurement includes one or more QoE measurements for the same service type and different sets of QoE measurement are for different service types. The at least one QoE measurement is selected from the at least one set of QoE measurement, and different QoE measurements of the at least one QoE measurement are for different service types.

Some yet other embodiments of the present application provide yet another method, which may be performed by a UE or the like in response to an inter-RAT handover from a RAN node with a RAT supporting more than one QoE measurement per service type to a target RAN node with another RAT supporting only one QoE measurement per service type. The exemplary method includes: receiving, from a RAN node (e.g., the source gNB or the like), first information indicating configuration of at least one set of QoE measurement; and receiving, from the RAN node, second information indicating configuration of at least one QoE measurement in response to an inter-RAT handover from the RAN node to a target RAN node (e.g., a ng-eNB or the like). Similarly, each set of QoE measurement includes one or more QoE measurements for the same service type and different sets of QoE measurement are for different service types. The at least one QoE measurement is selected from the at least one set of QoE measurement, and different QoE measurements of the at least one QoE measurement are for different service types.

Considering Scenarios 2, some embodiments of the present application provide a method, which may be performed by a RAN node with a first RAT supporting only one QoE measurement per service type, e.g., a source ng-eNB or the like. The exemplary method includes: transmitting, to a target RAN node with a second RAT supporting more than one QoE measurement per service type (e.g., a gNB or the like) in response to an inter-RAT handover, information indicating at least one QoE measurement and information indicating that the at least one QoE measurement has been configured to a UE with first RAT identification information (e.g., service type), wherein, different QoE measurements of the at least one QoE measurement are for different service types; receiving, from the target RAN node, second RAT identification information (e.g., measConfigAppLayerld) and information of associating the at least one QoE measurement with the second RAT identification information; and transmitting, to the UE, the second RAT identification information and the information of associating the at least one QoE measurement with the second RAT identification information.

Some other embodiments of the present application provide a method, which may be performed by a RAN node with a second RAT supporting more than one QoE measurement per service type, e.g., a target gNB or the like. The exemplary method includes: receiving, from a source RAN node with a first RAT supporting only one QoE measurement per service type (e.g., a ng-eNB or the like) in response to an inter-RAT handover, information indicating at least one QoE measurement and information indicating that the at least one QoE measurement has been configured to a UE with first RAT identification information (e.g., service type), wherein, different QoE measurements of the at least one QoE measurement are for different service types; and transmitting, to the source RAN node, second RAT identification information (e.g., measConfigAppLayerld) and information of associating the at least one QoE measurement identified by the first RAT identification information with the second RAT identification information.

FIG. 2 is a flow chart illustrating a method of supporting QoE measurement collection in Scenarios 1 according to some embodiments of the present application. Although the method is illustrated in a system level among a source RAN node, a target RAN node, and a remote apparatus; persons skilled in the art should understand that the method implemented in the source RAN node, the target RAN node and the remote apparatus can be separately implemented and/or incorporated by other apparatus with the like functions.

As illustrated above, in Scenarios 1, an inter-RAT handover is from a source RAN node with a RAT supporting more than one QoE measurement per service type (e.g., a NR RAN node, a gNB etc.) to a target RAN node with another RAT supporting only one QoE measurement per service type (e.g., a E-UTRA RAN node, a ng-eNB etc.).

Referring to FIG. 2, a source RAN node can configure at least one set of QoE measurement for a remote apparatus, e.g., a UE in response to QoE measurement being activated either by direct configuration from the OAM (not shown) (i.e., management-based activation), or by signalling from the OAM via a CN node, e.g., an AMF (i.e., signalling-based activation), containing UE-associated QoE configuration. Each set of QoE measurement includes one or more QoE measurements for the same service type and different sets of QoE measurement are for different service types. For example, the at least one set of QoE measurement may include a set of QoE measurement including one or more QoE measurements for streaming service. In another example, the at least one set of QoE measurement may include a set of QoE measurement including one or more QoE measurements for MTSI service. In yet another example, the at least one set of QoE measurement may include a first set of QoE measurement including one or more QoE measurements for streaming services and a second set of QoE measurement including one or more QoE measurements for MTSI service. Similar solutions are also applicable to other service type(s) in the future (if any).

For management-based QoE measurement activation, the OAM sends one or more QoE measurement configurations to the source RAN node. For signalling-based QoE measurements, the OAM initiates the QoE measurement activation for a specific UE via the CN node, e.g., the AMF, and the CN node sends the QoE measurement configuration information to the source RAN node for QoE measurement activation. Exemplary QoE measurement configuration information from the CN or OAM (also referred to as “CN/OAM QoE measurement configuration information”) includes:
QoE Reference: which is used to identify a QoE measurement between gNB and CN or between gNB and OAM;
Service Type: which indicates the service type of QoE measurements;
Container for Application Layer Measurement Configuration: which contains application layer measurement configuration; and
Area Scope: the area scope of the QoE measurement, which includes a list of cells, tracking area (TA), tracking area ID (TAI), or public land mobile network (PLMN) ID.
   Regarding QoE reference (or QoE Reference ID), it can be that as defined in clause 5.2 of TS 28.405, which is a OCTET string with SIZE(6). QoE reference consists of mobile country code (MCC), mobile network code (MNC) and QMC ID, where the MCC and MNC are coming with the trace activation request from a management system to identify one PLMN containing the management system, and QMC ID is a 3-bytes Octet string.

According to the QoE measurement information from the CN or OAM, the source RAN node will transmit first information indicating configuration of at least one set of QoE measurement to the UE in step 201, and accordingly, the UE will receive the first information. The configuration of the at least one set of QoE measurement indicated in the first information is in a first RAT supporting more than one QoE measurement per service type, e.g., NR QoE. For example, the source RAN node will provide the corresponding RRC QoE measurement configuration(s) to the UE in a downlink RRC message containing application layer measurement configuration (e.g., AppLayerMeasConfig), which includes:
MeasConfigAppLayerld: the measurement configuration application layer ID which is used to identify the application layer measurement configuration and report between the gNB and the UE; and
Container for Application Layer Measurement Configuration: which contains application layer measurement configuration.
   Regarding the measurement configuration application layer ID, it can be that as defined in TS 38.331 and is INTEGER (0.61, . . . ). The measurement configuration application layer ID will be mapped to the QoE Reference in the source RAN node.

Persons skilled in the art should well know that the above information elements (IE)s or parameters are only illustrated as examples, which may change as the evolution of 3GPP specification, and thus should be not used to unduly limit the protection scope of the present application.

Based on the received configuration of the at least one set of QoE measurement, the UE will perform the corresponding QoE measurement collection job. However, in step 203, the source RAN node may decide to perform an inter-system inter-RAT handover to a target RAN node, e.g., a ng-eNB. For example, the source RAN node may transmit a handover request message to the target RAN node in step 205, and the target RAN node may transmit a handover response message, e.g., a handover request acknowledgement (ACK) message in step 207.

In response to the inter-RAT handover, the source RAN node will transmit, to the UE, second information indicating configuration of at least one QoE measurement selected from the at least one set of QoE measurement in step 208, e.g., in a handover command (e.g., MobilityFromNRCommand) message. The configuration of the at least one QoE measurement indicated in the second information is in a second RAT different from the first RAT, e.g., a RAT supporting only one QoE measurement per service type (e.g., LTE QoE). Different QoE measurements of the at least one QoE measurement are for different service types. That is, the at least one QoE measurement is per service type, and only one QoE measurement is selected for the same service type. Accordingly, the UE will receive the second information indicating the configuration of the at least one QoE measurement and will continue the at least one QoE measurement after the inter-RAT handover. Other QoE measurement of the at least one set of QoE measurement except for the at least one QoE measurement will be stopped or released.

Regarding how to select the at least one QoE measurement with QoE measurement continuity from the at least one set of QoE measurement and/or how to indicate to the UE the QoE measurement continuity after inter-RAT handover, there are various manners.

According to some embodiments of the present application, a mechanism of indicating QoE measurement continuity after inter-RAT handover will be used to determine which QoE measurement per service type will be continued after inter-RAT handover.

In some embodiments of the present application, the information indicating QoE measurement continuity after inter-RAT handover (hereafter, inter-RAT QoE continuity indication) is received from an OAM system, or from the OAM system via the CN. The inter-RAT QoE continuity indication may be included in the UE application layer measurement information IE of the QMC configuration information IE in a NG-AP signalling. For example, for a certain service type, e.g., service type being streaming, the OAM system or CN may provide more than one QoE measurement configuration (e.g., application layer measurements), each QoE measurement configuration is uniquely identified by a QoE reference, e.g., QoE reference ID “1” for a first QoE measurement and QoE reference ID “2” for a second QoE measurement. The OAM system or CN will also provide an inter-RAT QoE continuity indication for one of the more than one QoE measurement per service type, which is used to indicate which QoE measurement will be continued per service type after inter-RAT handover, e.g., from a gNB to a ng-eNB. For example, an inter-RAT QoE continuity indication is configured for QoE measurement with QoE Reference ID “1” to indicate that QoE measurement with QoE Reference ID “1” for streaming services will be continued after inter-RAT handover.

Persons skilled in the art should well know that although for each service type, one QoE measurement is supported to be continued after the inter-RAT handover, it does not mean one QoE measurement must be continued for each service type. For example, in the case that there are a set of QoE measurement for streaming services and a set of QoE measurement for MTSI services, only one QoE measurement for streaming services or only one QoE measurement for MTSI services is configured to be continued after the inter-RAT handover in some embodiments of the present application.

The inter-RAT QoE continuity indication can be in various manners. For example, the inter-RAT QoE continuity indication from the OAM or CN may explicitly indicate which QoE measurement for a service type is continued after inter-RAT handover. In another example, the inter-RAT QoE continuity indication may implicitly indicate which QoE measurement for a service type is continued after inter-RAT handover, e.g., by indicating continuity priority of each QoE measurement for a service type after inter-RAT handover. The QoE measurement with the highest priority of more than one QoE measurement for a service type will be continued after the inter-RAT handover. In some cases, there may be only one QoE measurement in a set of QoE measurement for a service type, the service type can also be used as the inter-RAT QoE continuity indication, which implicitly indicates that the only one QoE measurement for the service type will be continued after the inter-RAT handover.

Based on the received inter-RAT QoE continuity indication, the source RAN node may select the at least one QoE measurement from the at least one set of QoE by itself in some embodiments of the present application (Scheme 1), or transmit the inter-RAT QoE continuity indication to the target RAN node and the at least one QoE measurement will be selected from the at least one set of QoE by the target RAN node (Scheme 2).

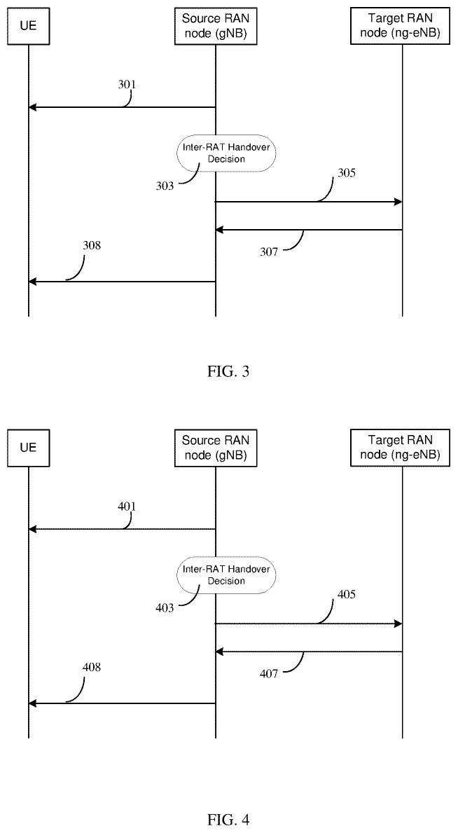

FIG. 3 is a flow chart illustrating a method of supporting QoE measurement collection with Scheme 1 in Scenarios 1 according to some embodiments of the present application. Although the method is illustrated in a system level among a source RAN node, a target RAN node, and a remote apparatus; persons skilled in the art should understand that the method implemented in the source RAN node, the target RAN node and the remote apparatus can be separately implemented and/or incorporated by other apparatus with the like functions. In addition, since the illustrated embodiments in view of FIG. 3 are also applicable in Scenarios 1, the embodiments illustrated for Scenarios 1 in view of FIG. 2 are also applicable to FIG. 3 and thus the same operations will be simplified or omit in the following descriptions.

Similarly, an inter-RAT handover is from a source RAN node with first RAT supporting more than one QoE measurement per service type (e.g., a NR RAN node, a gNB etc.) to a target RAN node with second RAT supporting only one QoE measurement per service type (e.g., a E-UTRA RAN node, a ng-eNB etc.).

Referring to FIG. 3, similar to step 201, the source RAN node can transmit the first information indicating configuration of at least one set of QoE measurement for a remote apparatus, e.g., a UE in step 301, which is in response to QoE measurement being activated either by direct configuration from the OAM (not shown) (i.e., management-based activation), or by signalling from the OAM via a CN node, e.g., an AMF (i.e., signalling-based activation), containing UE-associated QoE configuration.

The source RAN node also receives the inter-RAT QoE continuity indication from the OAM or CN, e.g., indicating that QoE measurement with QoE Reference ID “1” will be continued after inter-RAT handover. According to some embodiments of the present application, the source RAN node will also transmit the inter-RAT QoE continuity indication to the UE with the first information in step 301.

For example, the source RAN node will provide the UE the configuration of the at least one set of QoE measurement in the first RAT with the inter-RAT QoE continuity indication by application layer configuration (e.g. AppLayerMeasConfig IE) in a RRC reconfiguration message, wherein each configuration of the at least one set of QoE measurement is identified by first RAT identification information, e.g., a measConfigAppLayerld conveyed in the RRC signaling, which can identify the application layer measurement configuration and report between the source RAN node and the UE. The measConfigAppLayerld will be mapped to the QoE reference, e.g., measConfigAppLayerld “1” is mapped to QoE reference ID “1,” and measConfigAppLayerld “1” is mapped to QoE reference ID “2.” In the case that the access stratum (AS) layer of the UE receives the inter-RAT QoE continuity indication, the AS layer may forward the inter-RAT QoE continuity indication to the application layer of the UE.

In the case that the source RAN node decides to perform an inter-system inter-RAT handover to the target RAN node in step 303, the source RAN node may select the at least one QoE measurement from the at least one set of QoE measurement based on the inter-RAT QoE continuity indication. Each of the at least one QoE measurement is for different service types as required in the second RAT. In step 305, the source RAN node will transmit third information indicating only the configuration of the at least one QoE measurement to the target RAN node, e.g., via a handover request message or via a source to target transparent container.

For example, based on the inter-RAT QoE continuity indication configured for QoE measurement with QoE Reference ID “1,” the source RAN node will select the QoE measurement with QoE Reference ID “1,” and will only include the configuration of QoE measurement with QoE Reference ID “1” to the target RAN node, e.g., in the handover request message in step 305. In some other embodiments, the source RAN node may also generate the QoE measurement configuration in second RAT, e.g., LTE RRC QoE configuration of the QoE measurement configuration, and include it in the source to target transparent container to the target RAN node. The LTE RRC QoE configuration can be encoded in LTE RRC ASN.1 format.

After receiving the configuration of the at least one QoE measurement configuration, e.g., the configuration of QoE measurement with QoE Reference ID “1,” the target RAN node will generate the LTE RRC QoE configuration for the UE based on the received QoE measurement configuration or update the received LTE RRC QoE configuration to provide the updated LTE RRC QoE configuration for the UE. In step 307, the target RAN node will send the generated or updated LTE RRC QoE configuration to the source RAN node, e.g., via a target RAT message container in a handover response message. In the LTE RRC QoE configuration provided by the target RAN node, only service type, e.g., “streaming” is provided without any measConfigAppLayerld.

After receiving the configuration of the at least one QoE measurement in the second RAT, e.g., LTE RRC QoE configuration of QoE measurement with QoE Reference ID “1,” the source RAN node will forward it to the UE in step 308, e.g., in the MobilityFromNRCommand message. That is, corresponding to step 208, the source RAN node will transmit second information indicating the configuration of the selected at least one QoE measurement to the UE in step 308, wherein the configuration of the selected at least one QoE measurement is in the second RAT.

Based on the inter-RAT QoE continuity indication received from the source RAN node and the configuration of the selected at least one QoE measurement in the second RAT, e.g., the LTE RRC QoE configuration per service type, the UE can determine which QoE measurement per service type will be continued after the inter-RAT handover. Accordingly, the UE will continue the at least one QoE measurement, e.g., continuing the QoE measurement for streaming with measConfigAppLayerld “1” mapped to QoE Reference ID “1” indicated by the inter-RAT QoE continuity indication. The UE will stop or release other QoE measurement(s), e.g., stopping or releasing the QoE measurement for streaming with measConfigAppLayerld “2” mapped to QoE Reference ID “2.”

Besides transmitting the inter-RAT QoE continuity indication to the UE with the first information, in some other embodiments of the present application, the source RAN node may transmit the inter-RAT QoE continuity indication to the UE with the second information in step 308, e.g., in the MobilityFromNRCommand message.

For example, the inter-RAT QoE continuity indication is provided in an exemplary MobilityFromNRCommand message together with LTE RRC QoE Configuration as follows:

MobilityFromNRCommand := {
inter-RAT QoE continuity indication measConfigAppLayerId;
RRC container incl. LTE RRC QoE Configuration}

When the UE receives the configuration of the at least one QoE measurement in the second RAT in the MobilityFromNRCommand message, the UE will continue the QoE measurement of a certain service type with the inter-RAT QoE continuity indication and release other QoE configuration(s) of the same service type.

In some embodiments of the present application, the inter-RAT QoE continuity indication may be indicated to the UE in an implicit manner, e.g., by transmitting information indicating releasing other QoE measurement of the at least one set of QoE measurement except for the at least one QoE measurement, e.g., in the MobilityFromNRCommand message.

For example, according the inter-RAT QoE continuity indication, the source RAN node may trigger to release the other QoE measurement (s) of the same service type which is not indicated with the inter-RAT QoE continuity, e.g., the QoE measurement for streaming with measConfigAppLayerld “2.” The source RAN node will include the measConfigAppLayerld of the QoE measurement to be released in an exemplary MobilityFromNRCommand message as follows:

Mobility FromNRCommand := {
measConfigAppLayerToRelease measConfigAppLayerId;
RRC container incl. LTE RRC QoE Configuration}

After receiving the MobilityFromNRCommand message, the UE will release the QoE measurement(s) indicated to be released, and will keep and continue the QoE measurement(s) that will not be released after the inter-RAT handover from the source RAN node to the target RAN node, e.g., performing the QoE measurement and/or transmitting the QoE measurement reporting to the target RAN node.

### Scheme 2

FIG. 4 is a flow chart illustrating a method of supporting QoE measurement collection with Scheme 2 in Scenarios 1 according to some embodiments of the present application. Although the method is illustrated in a system level among a source RAN node, a target RAN node, and a remote apparatus; persons skilled in the art should understand that the method implemented in the source RAN node, the target RAN node and the remote apparatus can be separately implemented and/or incorporated by other apparatus with the like functions. In addition, since the illustrated embodiments in view of FIG. 4 are also applicable in Scenarios 1, the embodiments illustrated for Scenarios 1 in view of FIG. 2 are also applicable to FIG. 4 and thus the same operations will be simplified or omit in the following descriptions.

Similarly, an inter-RAT handover is from a source RAN node with first RAT supporting more than one QoE measurement per service type (e.g., a NR RAN node, a gNB etc.) to a target RAN node with second RAT supporting only one QoE measurement per service type (e.g., a E-UTRA RAN node, a ng-eNB etc.).

Referring to FIG. 4, similar to step 201, the source RAN node can transmit, to a remote apparatus, e.g., a UE, the first information indicating configuration of at least one set of QoE measurement in first RAT in step 401, which is in response to QoE measurement being activated either by direct configuration from the OAM (not shown) (i.e., management-based activation), or by signalling from the OAM via a CN node, e.g., an AMF (i.e., signalling-based activation), containing UE-associated QoE configuration. The source RAN node also receives the inter-RAT QoE continuity indication from the OAM or CN, e.g., indicating that QoE measurement with QoE Reference ID “1” will be continued after inter-RAT handover. However, the inter-RAT QoE continuity indication is unnecessary in step 401.

For example, the source RAN node will provide the UE the configuration of the at least one set of QoE measurement in the first RAT by application layer configuration (e.g. AppLayerMeasConfig IE) in a RRC reconfiguration message, wherein each configuration of the at least one set of QoE measurement is identified by first RAT identification information, e.g., a measConfigAppLayerld conveyed in the RRC signaling, which can identify the application layer measurement configuration and report between the source RAN node and the UE. The measConfigAppLayerld will be mapped to the QoE reference, e.g., measConfigAppLayerld “1” is mapped to QoE reference ID “1,” and measConfigAppLayerld “2” is mapped to QoE reference ID “2.”

In the case that the source RAN node decides to perform an inter-system inter-RAT handover to the target RAN node in step 403, the source RAN node will not select the QoE measurement(s). Instead, the source RAN node will transmit third information indicating configuration of the at least one set of QoE measurement and the inter-RAT QoE continuity indication to the target RAN node in step 405, e.g., via a handover request message or via a source to target transparent container.

For example, the source RAN node will provide the UE application layer measurement information IE of the QMC configuration information IE in an XnAP handover request message. The source RAN node will also provide the second RAT identification information, e.g., the configured measConfigAppLayerld of each QoE measurement to the target RAN node in the same XnAP message. For example, the source RAN node will provide measConfigAppLayerld “1” of the QoE measurement with QoE Reference ID “1,” measConfigAppLayerld “2” of the QoE measurement with QoE Reference ID “2” to the target RAN node. The source RAN node may also provide the inter-RAT QoE continuity indication to the target RAN node.

After receiving the third information and the inter-RAT QoE continuity indication, the target RAN node will select at least one QoE measurement from the at least one set of QoE measurement that will be kept and continued according to the inter-RAT QoE continuity indication. For example, since only QoE measurement with QoE reference “1” is indicated to be continued after inter-RAT handover by the inter-RAT QoE continuity indication, the target RAN node will select the QoE measurement with QoE reference ID “1” to be kept and continued after the inter-RAT handover. In the case that the inter-RAT QoE continuity indication is represented as a continuity priority of QoE measurement after inter-RAT handover, the target RAN node will decide to select a QoE measurement with the highest continuity priority among the one or more QoE measurements for the same service type.

Similarly, the target RAN node will generate the configuration of the at least one QoE measurement in the second RAT, e.g., LTE RRC QoE configuration for the UE based on the received QoE measurement configuration or update the received LTE RRC QoE configuration to provide the updated LTE RRC QoE configuration for the UE. In step 407, the target RAN node will send the generated or updated configuration of the at least one QoE measurement in the second RAT, e.g., LTE RRC QoE configuration to the source RAN node with the corresponding second RAT identification information, e.g., measConfigAppLayerld, e.g., in a handover response message. The measConfigAppLayeId can be included in the LTE RRC QoE configuration in some embodiments of the present application.

After receiving the configuration of the at least one QoE measurement in the second RAT, e.g., LTE RRC QoE configuration of QoE measurement with corresponding measConfigAppLayerld, the source RAN node will forward it to the UE in step 408, e.g., in the MobilityFromNRCommand message.

Based on the LTE QoE configuration including the corresponding NR measConfigAppLayeId in the MobilityFromNRCommand message received from the source RAN node, the UE will continue the at least one QoE measurement with the corresponding measConfigAppLayeId, e.g., continuing the QoE measurement for streaming with measConfigAppLayerId “1” mapped to QoE Reference ID “1.” The UE will stop or release other QoE measurement(s), e.g., stopping or releasing the QoE measurement for streaming with measConfigAppLayerId “2” mapped to QoE Reference ID “2.”

In some other embodiments of the present application, in step 407, the target RAN node may transmit information indicating QoE measurement to be released to the source RAN node, e.g., a QoE measurement release list in a handover response message. The QoE measurement release list may also present a QoE deactivation list which includes a list of QoE reference ID of the QoE measurement to be released or deactivated.

In some other embodiments of the present application, in step 407, the target RAN node may transmit information indicating QoE measurement to be continued and kept to the source RAN node, e.g., by including a QoE measurement kept list (or continuity list) to the source RAN node in the handover response message to indicate the QoE measurement will be continued and kept after inter-RAT handover.

In some yet other embodiments of the present application, the target RAN node may transmit both the QoE measurement release list and the QoE measurement kept list to the source RAN node.

After the source RAN node receives the QoE measurement release list and/or the QoE measurement kept list in the handover response message, the source gNB will send a corresponding QoE measurement release list, e.g., measConfigAppLayerToReleaseList to the UE to release the listed QoE measurements in step 408. The measConfigAppLayerToReleaseList may include a list of measConfigAppLayerld of the QoE measurement(s) to be released. In some other embodiments of the present application, the source RAN node may send a corresponding QoE measurement kept list, e.g., a measConfigAppLayerToKeptList to indicate the QoE measurement(s) to be kept and continued. In some other embodiments of the present application, the source RAN node may send both the measConfigAppLayerToReleaseList and measConfigAppLayerToKeptList to the UE in step 408. The measConfigAppLayerToReleaseList and/or measConfigAppLayerToKeptList can be included in the MobilityFromNRCommand message.

After receiving the MobilityFromNRCommand message, the UE will release the QoE measurements indicated in the measConfigAppLayerToReleaseList and keep (continue) the other QoE measurement(s); and/or UE will keep the QoE measurement(s) in the measConfigAppLayerToKeptList and release other QoE measurement(s).

In some other embodiments of the present application, the source RAN node may select the at least one QoE measurement based on it implementations in Scheme 1, that is, the inter-RAT QoE continuity indication can be generated by the source RAN node instead of being received from the OAM directly or via the CN. In Scheme 2, the source RAN node may also transmit the inter-RAT QoE continuity indication generated by itself to the target RAN node. Similarly, the target RAN node may select the at least one QoE measurement based on its implementations in Scheme 2, that is, the inter-RAT QoE continuity indication can be generated by the target RAN node instead of being provided by the source RAN node.

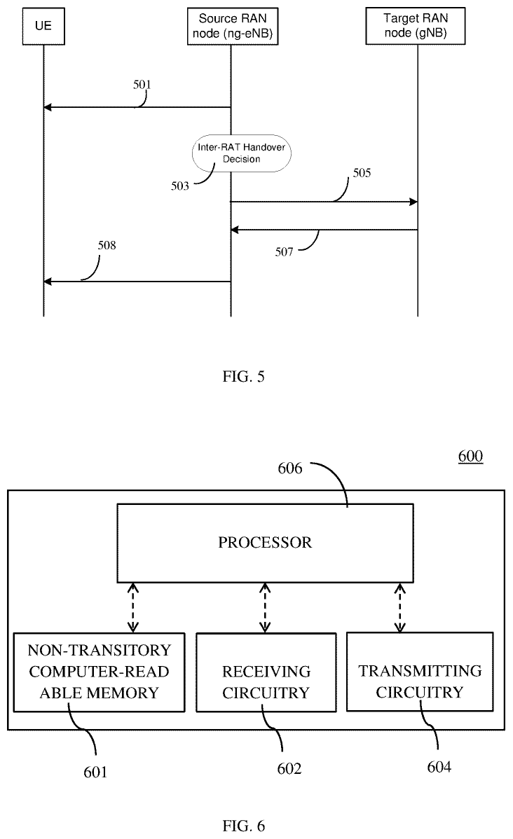

FIG. 5 is a flow chart illustrating a method of supporting QoE measurement collection in Scenarios 2 according to some embodiments of the present application. Although the method is illustrated in a system level among a source RAN node, a target RAN node, and a remote apparatus; persons skilled in the art should understand that the method implemented in the source RAN node, the target RAN node and the remote apparatus can be separately implemented and/or incorporated by other apparatus with the like functions.

As illustrated above, in Scenarios 2, an inter-RAT handover is from a source RAN node with a first RAT supporting only one QoE measurement per service type (e.g., a E-UTRA RAN node, a ng-eNB etc.) to a target RAN node with a second RAT supporting more than one QoE measurement per service type (e.g., a NR RAN node, a gNB etc.).

Referring to FIG. 5, a source RAN node can configure at least one QoE measurement for a remote apparatus, e.g., a UE in response to QoE measurement being activated either by direct configuration from the OAM (not shown) (i.e., management-based activation), or by signalling from the OAM via a CN node, e.g., an AMF (i.e., signalling-based activation), containing UE-associated QoE configuration. Each QoE measurement is for a service type and different QoE measurements are for different service types. That is, the QoE measurement is per service type, and is implicitly identified by the service type. For example, the at least one QoE measurement may include at least one of a QoE measurement for streaming services or a QoE measurement for MTSI services. Similar solutions are also applicable to other service type(s) in the future (if any).

In step 501, the source RAN node, e.g., a ng-eNB will transmit the configuration of the at least one QoE measurement with first RAT identification information, e.g., service type to the UE. For example, the source RAN node may transmit a UE application layer configuration (e.g. AppLayerMeasConfig IE) in a RRC reconfiguration message and the corresponding service type, e.g., streaming services will be indicated to the UE.

In step 503, the source RAN node may decide to perform an inter-system inter-RAT handover to the target RAN node, e.g., a gNB. The source RAN node will transmit the configuration of the at least one QoE measurement to the target RAN node in step 505, e.g., by transmitting the UE application layer measurement information IE of the QMC configuration information IE in a XnAP handover request message. The source RAN node may also provide information indicating that the at least one QoE measurement has been configured to a UE with first RAT identification information (hereafter, indication information), e.g., an indication indicating whether the QoE measurement has been already configured to the UE in LTE QoE. The indication information also represents the QoE measurement is ongoing when the inter-RAT handover happens.

After receiving the at least one QoE measurement and the indication information, the target RAN node will identify the QoE measurement that has been already configured to the UE in the first RAT (e.g., LTE QoE). The target RAN node will allocate (or assign) second RAT identification information, e.g., a measConfigAppLayerld to each of the at least one QoE measurement. In step 507, the target RAN node will send the second RAT identification information for the at least one QoE measurement and information of associating the at least one QoE measurement with second RAT identification information (hereafter, association information) to the source RAN node, e.g., in a handover request acknowledge message, which will indicate the UE to associate the on-going QoE measurement identified by the first RAT identification information with the second RAT identification information. In some embodiments of the present application, the association information can be implicitly indicated by the second RAT identification information. For example, the on-going QoE measurement association information may be implicated indicated by including the measConfigAppLayerld of one QoE measurement for a service type.

The target RAN node will generate the configuration of the at least one QoE measurement in the second RAT, e.g., NR QoE measurement configuration, and transmit the configuration of the at least one QoE measurement in the second RAT to the source RAN node, e.g., in the handover request acknowledge message.

The source RAN node will forward the received information to the UE, e.g., in a MobilityFromE-UTRACommand message in step 508. After receiving the association information and measConfigAppLayerld, the UE will associate the on-going QoE measurement with the allocated measConfigLayerId and continue the QoE measurement after the inter-RAT handover, including transmitting the QoE measurement report to the target node. In some embodiments, the UE RRC layer will forward the received association information and measConfigAppLayerld to the UE application layer. The UE application layer will associate the on-going QoE measurement with the allocated measConfigLayerId and continue the QoE measurement after the inter-RAT handover, including transmitting the QoE measurement report to the target node.

Besides methods, embodiments of the present application also propose an apparatus of supporting QoE measurement collection.

For example, FIG. 6 illustrates a block diagram of an apparatus 600 of supporting QoE measurement reporting according to some other embodiments of the present application.

As shown in FIG. 6, the apparatus 600 may include at least one non-transitory computer-readable medium 601, at least one receiving circuitry 602, at least one transmitting circuitry 604, and at least one processor 606 coupled to the non-transitory computer-readable medium 601, the receiving circuitry 602 and the transmitting circuitry 604. The apparatus 600 may be a RAN node or a terminal device (e.g., a UE) configured to perform a method illustrated in the above or the like.

Although in this figure, elements such as the at least one processor 606, transmitting circuitry 604, and receiving circuitry 602 are described in the singular, the plural is contemplated unless a limitation to the singular is explicitly stated. In some embodiments of the present application, the receiving circuitry 602 and the transmitting circuitry 604 can be combined into a single device, such as a transceiver. The processor 606 may be a CPU, a DSP, a microprocessor etc. In certain embodiments of the present application, the apparatus 600 may further include an input device, a memory, and/or other components.

In some embodiments of the present application, the non-transitory computer-readable medium 601 may have stored thereon computer-executable instructions to cause the processor 606 to implement the method with respect to the RAN node, e.g., a gNB or a ng-eNB as described above. For example, the computer-executable instructions, when executed, cause the processor 606 interacting with receiving circuitry 602 and transmitting circuitry 604, so as to perform the steps with respect to a RAN node as depicted above.

In some other embodiments of the present application, the non-transitory computer-readable medium 601 may have stored thereon computer-executable instructions to cause a processor to implement the method with respect to the UE as described above. For example, the computer-executable instructions, when executed, cause the processor 606 interacting with receiving circuitry 602 and transmitting circuitry 604, so as to perform the steps with respect to a UE as depicted above.

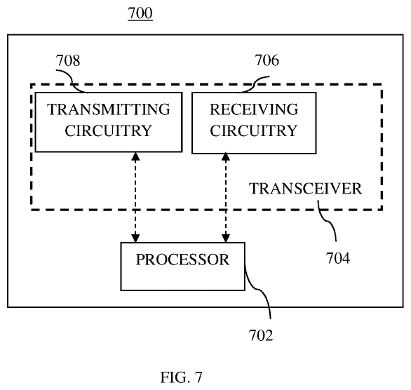

FIG. 7 is a block diagram of an apparatus of supporting QoE measurement collection according to some embodiments of the present application.

Referring to FIG. 7, the apparatus 700, e.g., a UE or a RAN node, e.g., a source RAN node or a target RAN node, may include at least one processor 702 and at least one transceiver 704. The transceiver 704 may include at least one separate receiving circuitry 706 and transmitting circuitry 708, or at least one integrated receiving circuitry 706 and transmitting circuitry 708. The at least one processor 702 may be a CPU, a DSP, a microprocessor etc.

According to some embodiments of the present application, when the apparatus 700 is a RAN node, e.g., a source gNB, the apparatus is configured to: transmit, to a UE, first information indicating configuration of at least one set of QoE measurement, wherein, each set of QoE measurement includes one or more QoE measurements for a same service type and different sets of QoE measurement are for different service types; and transmit, to the UE, second information indicating configuration of at least one QoE measurement in response to an inter-RAT handover to a target RAN node, wherein the at least one QoE measurement is selected from the at least one set of QoE measurement, and different QoE measurements of the at least one QoE measurement are for different service types.

According to some embodiments of the present application, when the apparatus 700 is a RAN node, e.g., a target ng-eNB, the apparatus is configured to: receive, from a source RAN node in response to an inter-RAT handover, first information indicating configuration of at least one set of QoE measurement, wherein, each set of QoE measurement includes one or more QoE measurements for a same service type and different sets of QoE measurement are for different service types; and transmit, to the source RAN node, second information indicating configuration of at least one QoE measurement, wherein, the at least one QoE measurement is selected from the at least one set of QoE measurement, and different QoE measurements of the at least one QoE measurement are for different service types.

According to some embodiments of the present application, when the apparatus 700 is a RAN node, e.g., a source ng-eNB, the apparatus is configured to: transmit, to a target RAN node in response to an inter-RAT handover, information indicating at least one QoE measurement and information indicating that the at least one QoE measurement has been configured to a UE with first RAT identification information, wherein, different QoE measurements of the at least one QoE measurement are for different service types; receive, from the target RAN node, second RAT identification information and information of associating the at least one QoE measurement with second RAT identification information; and transmit, to the UE, the second RAT identification information and the information of associating the at least one QoE measurement with the second RAT identification information.

According to some embodiments of the present application, when the apparatus 700 is a RAN node, e.g., a target gNB, the apparatus is configured to: receive, from a source RAN node in response to an inter-RAT handover, information indicating at least one QoE measurement and information indicating that the at least one QoE measurement has been configured to a UE with first RAT identification information, wherein, different QoE measurements of the at least one QoE measurement are for different service types; and transmit, to the source RAN node, second RAT identification information and information of associating the at least one QoE measurement identified by the first RAT identification information with the second RAT identification information.

According to some embodiments of the present application, when the apparatus 700 is a UE, the apparatus may be configured to: receive, from a RAN node, first information indicating configuration of at least one set of QoE measurement, wherein, each set of QoE measurement includes one or more QoE measurements for a same service type and different sets of QoE measurement are for different service types; and receive, from the RAN node, second information indicating configuration of at least one QoE measurement in response to an inter-RAT handover from the RAN node to a target RAN node, wherein the at least one QoE measurement is selected from the at least one set of QoE measurement, and different QoE measurements of the at least one QoE measurement are for different service types.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus including a processor and a memory. Computer programmable instructions for implementing a method stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A base station for wireless communication, comprising:
at least one memory; and
at least one processor coupled with the at least one memory and configured to cause the base station to:
transmit first information indicating configuration of at least one set of quality of experience (QoE) measurement, wherein each set of QoE measurement includes one or more QoE measurements for a same service type and different sets of QoE measurement are for different service types; and
transmit second information indicating configuration of at least one QoE measurement in response to an inter-radio access technology (RAT) handover to a target RAN node, wherein the at least one QoE measurement is selected from the at least one set of QoE measurement, and different QoE measurements of the at least one QoE measurement are for different service types.

2. The base station of claim 1, wherein the at least one processor is configured to cause the base station to:
receive information indicating QoE measurement continuity after inter-RAT handover from an operation administration and maintenance (OAM) system, or from the OAM system via a core network (CN), wherein the at least one QoE measurement is selected based on the information indicating QoE measurement continuity after inter-RAT handover.

3. The base station of claim 2, wherein the information indicating QoE measurement continuity after inter-RAT handover indicates which QoE measurement for a service type is continued after inter-RAT handover, or indicates continuity priority of each QoE measurement for a service type after inter-RAT handover.

4. The base station of claim 2, wherein the at least one processor is configured to cause the base station to:
select the at least one QoE measurement based on the information indicating QoE measurement continuity;
transmit third information indicating only the configuration of the at least one QoE measurement to the target RAN node; and
receive the second information indicating the configuration of the at least one QoE measurement from the target RAN node, wherein the configuration of the at least one QoE measurement indicated in the second information is generated or updated based on the configuration of the at least one QoE measurement indicated in the third information.

5. The base station of claim 2, wherein the at least one is configured to cause the base station to:
transmit third information indicating configuration of the at least one set of QoE measurement and the information indicating QoE measurement continuity after inter-RAT handover to the target RAN node; and
receive the second information indicating the configuration of the at least one QoE measurement from the target RAN node, wherein the configuration of the at least one QoE measurement indicated in the second information is generated or updated based on the configuration of the at least one set of QoE measurement indicated in the third information.

6. The base station of claim 1, wherein the configuration of at least one set of QoE measurement indicated in the first information is in a first RAT, and the configuration of at least one QoE measurement indicated in the second information is in a second RAT different from the first RAT.

7-11. (canceled)

12. A user equipment (UE) for wireless communication, comprising:
at least one memory; and
at least processor coupled with the at least one memory and configured to cause the UE to:
receive first information indicating configuration of at least one set of quality of experience (QoE) measurement, wherein each set of QoE measurement includes one or more QoE measurements for a same service type and different sets of QoE measurement are for different service types; and
receive second information indicating configuration of at least one QoE measurement in response to an inter-radio access technology (RAT) handover from a first radio access network (RAN) node to a second RAN node, wherein the at least one QoE measurement is selected from the at least one set of QoE measurement, and different QoE measurements of the at least one QoE measurement are for different service types.

13. The UE of claim 12, wherein the at least one processor is configured to cause the UE to:
receive information indicating QoE measurement continuity after inter-RAT handover with at least one of the first information or the second information; and
continue the at least one QoE measurement after inter-RAT handover based on the information indicating QoE measurement continuity after inter-RAT handover.

14. The UE of claim 12, wherein the at least one processor is configured to cause the UE to:
receive information indicating that the at least one QoE measurement is to be continued in response to the inter-RAT handover; and
continue the at least one QoE measurement after the inter-RAT handover.

15. The UE of claim 12, wherein the configuration of at least one set of QoE measurement indicated in the first information is in a first RAT, and the configuration of at least one QoE measurement indicated in the second information is in a second RAT different from the first RAT.

16. The UE of claim 12, wherein the at least one processor is configured to cause the UE to receive the first information from the first RAN node and receive the second information from the first RAN node.

17. A processor for wireless communication, comprising:
at least one controller coupled with at least one memory and configured to cause the processor to:
receive first information indicating configuration of at least one set of quality of experience (QoE) measurement, wherein each set of QoE measurement includes one or more QoE measurements for a same service type and different sets of QoE measurement are for different service types; and
receive second information indicating configuration of at least one QoE measurement in response to an inter-radio access technology (RAT) handover from a first radio access network (RAN) node to a second RAN node, wherein the at least one QoE measurement is selected from the at least one set of QoE measurement, and different QoE measurements of the at least one QoE measurement are for different service types.

18. The processor of claim 17, wherein the at least one controller is configured to cause the processor to:
receive information indicating QoE measurement continuity after inter-RAT handover with at least one of the first information or the second information; and
continue the at least one QoE measurement after inter-RAT handover based on the information indicating QoE measurement continuity after inter-RAT handover.

19. The processor of claim 17, wherein the at least one controller is configured to cause the processor to:
receive information indicating that the at least one QoE measurement is to be continued in response to the inter-RAT handover; and
continue the at least one QoE measurement after the inter-RAT handover.

20. The processor of claim 17, wherein the configuration of at least one set of QoE measurement indicated in the first information is in a first RAT, and the configuration of at least one QoE measurement indicated in the second information is in a second RAT different from the first RAT.

21. The processor of claim 17, wherein the at least one controller is configured to cause the processor to receive the first information from the first RAN node and receive the second information from the first RAN node.

22. A method performed by a user equipment (UE), the method comprising:
receiving first information indicating configuration of at least one set of quality of experience (QoE) measurement, wherein each set of QoE measurement includes one or more QoE measurements for a same service type and different sets of QoE measurement are for different service types; and
receiving second information indicating configuration of at least one QoE measurement in response to an inter-radio access technology (RAT) handover from a first radio access network (RAN) node to a second RAN node, wherein the at least one QoE measurement is selected from the at least one set of QoE measurement, and different QoE measurements of the at least one QoE measurement are for different service types.

23. The method of claim 22, further comprising:
receiving information indicating QoE measurement continuity after inter-RAT handover with at least one of the first information or the second information; and
continuing the at least one QoE measurement after inter-RAT handover based on the information indicating QoE measurement continuity after inter-RAT handover.

24. The method of claim 22, further comprising:
receiving information indicating that the at least one QoE measurement is to be continued in response to the inter-RAT handover; and
continuing the at least one QoE measurement after the inter-RAT handover.

25. The method of claim 22, wherein the configuration of at least one set of QoE measurement indicated in the first information is in a first RAT, and the configuration of at least one QoE measurement indicated in the second information is in a second RAT different from the first RAT.
